(19) United States
(12) Patent Application Publication
(10) Pub. No.: US 2015/0024942 A1
(43) Pub. Date: Jan. 22, 2015

(54) SUPERCONDUCTING WIRE

(71) Applicant: FURUKAWA ELECTRIC CO., LTD., Tokyo (JP)

(72) Inventors: Yuko Hayase, Tokyo (JP); Hiroyuki Fukushima, Tokyo (JP); Hideyuki Hatakeyama, Tokyo (JP); Yoshikazu Okuno, Tokyo (JP); Yoshinori Nagasu, Tokyo (JP); Masaru Higuchi, Tokyo (JP); Hisaki Sakamoto, Tokyo (JP)

(73) Assignee: FURUKAWA ELECTRIC CO., LTD., Tokyo (JP)

(21) Appl. No.: 14/236,119

(22) PCT Filed: Mar. 27, 2013
(86) PCT No.: PCT/JP2013/059119

§ 371 Date: Jan. 30, 2014

(30) Foreign Application Priority Data
Apr. 6, 2012 (JP) 2012-087675

(51) Int. Cl. H01B 12/06; H01B 12/04

(52) U.S. Cl. CPC H01B 12/06; H01B 12/04
USPC 505/230; 428/389

(57) ABSTRACT

A superconducting wire has: a substrate; a superconducting layer that is layered on one main surface side of the substrate; a stabilization layer that covers a surface of the superconducting layer and another main surface of the substrate; and an insulating layer that covers a surface of the stabilization layer, and that has an identification portion that identifies the substrate side and the superconducting layer side.

### TECHNICAL FIELD

The present invention relates to a superconducting wire.

### BACKGROUND ART

There are conventionally known superconducting wires that have a stabilization layer that covers the peripheries of a substrate and a superconducting layer that is layered on one main surface side of the substrate.

However, in such a superconducting wire, the superconducting layer and the substrate cannot be recognized visually, and it is difficult to identify the substrate side and the superconducting layer side unless the superconducting wire is cut.

Thus, Japanese Patent Application Laid-Open (JP-A) No. 2011-154790 and U.S. Pat. No. 7,702,373 disclose superconducting wires at which an identification mark, for identifying the side at which the superconducting layer is provided, is provided at the surface of either of the stabilization layer that is positioned at the substrate side or the stabilization layer that is positioned at the superconducting layer side, of the stabilization layer that covers the peripheries of the substrate and the superconducting layer.

Further, Japanese Patent No. 4423708 discloses a superconducting wire in which (the periphery of) the stabilization layer described in JP-A No. 2011-154790 is further covered by an insulating layer at which a copper layer has been subjected to an oxidation treatment (a copper oxide layer).

Similarly, JP-A No. 2011-233294 discloses a superconducting wire at which the periphery of the superconducting wire is covered by an insulating layer (resin tape).

### SUMMARY OF INVENTION

### Technical Problem

However, with the identification marks that are described in JP-A No. 2011-154790 and U.S. Pat. No. 7,702,373, in a case in which the stabilization layer is covered by an insulating layer as in Japanese Patent No. 4423708 or JP-A No. 2011-233294, the identification mark that is at the stabilization layer or the like cannot be recognized visually, and, ultimately, it is difficult to identify the substrate side and the superconducting layer side.

The present invention was made in consideration of the above-described circumstances, and an object thereof is to provide a superconducting wire whose substrate side and superconducting layer side can be easily identified even if a stabilization layer is covered by an insulating layer.

### Solution to Problem

The above-described problem to be solved of the present invention is solved by the following means.
<1> A superconducting wire comprising: a substrate; a superconducting layer that is layered on one main surface side of the substrate; a stabilization layer that covers a surface of the superconducting layer and another main surface of the substrate; and an insulating layer that covers a surface of the stabilization layer, and that has an identification portion that identifies the substrate side and the superconducting layer side.
<2> The superconducting wire of <1>, wherein the stabilization layer contains a metal element, and the insulating layer has, as the identification portion, a metal oxide insulating portion that is formed at least at the superconducting layer side and contains an oxide of the metal element.
<3> The superconducting wire of <2>, wherein the metal oxide insulating portion has, as the identification portion, a first metal oxide insulating portion that is formed at the superconducting layer side and a second metal oxide insulating portion that is formed at the substrate side, and colors of the first metal oxide insulating portion and the second metal oxide insulating portion differ from one another.
<4> The superconducting wire of <3>, wherein a thickness of the first metal oxide insulating portion is greater than a thickness of the second metal oxide insulating portion.
<5> The superconducting wire of any one of <2> through <4>, wherein a thickness of the metal oxide insulating portion is smaller than a thickness of the stabilization layer.
<6> The superconducting wire of any one of <2> through <5>, wherein, between the metal oxide insulating portion and the stabilization layer, the metal element and an oxide of the metal element both exist, and there is provided a sloping-composition layer in which a ratio of the oxide of the metal element with respect to the metal element as a simple substance continuously becomes greater toward the metal oxide insulating portion.
<7> The superconducting wire of any one of <2> through <6>, wherein the metal oxide insulating portion has an end portion identification portion that identifies one end portion and another end portion in a length direction of the superconducting wire or one end portion and another end portion in a short-side direction of the superconducting wire.
<8> The superconducting wire of any one of <1> through <7>, wherein a surface roughness of the superconducting layer side at the insulating layer is different than a surface roughness of the substrate side at the insulating layer.
<9> The superconducting wire of any one of <1> through <8>, wherein a Vickers hardness of the superconducting layer side at the insulating layer is different than a Vickers hardness of the substrate side at the insulating layer.

### Advantageous Effects of Invention

In accordance with the present invention, there can be provided a superconducting wire whose substrate side and superconducting layer side can be easily identified even if a stabilization layer is covered by an insulating layer.

### BRIEF DESCRIPTION OF DRAWINGS

FIG. 1 is a perspective view showing the layered structure of a superconducting wire relating to an embodiment of the present invention.

FIG. 2A is an end surface view of the superconducting wire shown in FIG. 1.

FIG. 2B is a drawing showing a surface at a superconducting layer side of the superconducting wire shown in FIG. 1.

FIG. 2C is a drawing showing a surface at a substrate side of the superconducting wire shown in FIG. 1.

FIG. 3A is a drawing showing some of the processes of fabricating a metal oxide insulating portion.

FIG. 3B is a drawing showing, in continuation from FIG. 3A, some of the processes of fabricating the metal oxide insulating portion.

FIG. 3C is a drawing showing, in continuation from FIG. 3B, some of the processes of fabricating the metal oxide insulating portion.

FIG. 4A is a drawing showing some of other processes of fabricating the metal oxide insulating portion.

FIG. 4B is a drawing showing, in continuation from FIG. 4A, some of the other processes of fabricating the metal oxide insulating portion.

FIG. 4C is a drawing showing, in continuation from FIG. 4B, some of the other processes of fabricating the metal oxide insulating portion.

FIG. 5A is a drawing showing a modified example of the superconducting wire relating to the embodiment of the present invention.

FIG. 5B is a drawing showing another modified example of the superconducting wire relating to the embodiment of the present invention.

### DESCRIPTION OF EMBODIMENTS

A superconducting wire relating to an embodiment of the present invention is described concretely hereinafter with reference to the appended drawings. Note that, throughout the respective drawings, members (structural elements) having the same or corresponding functions are denoted by the same reference numerals, and description thereof is omitted appropriately.

### Schematic Structure of Superconducting Wire

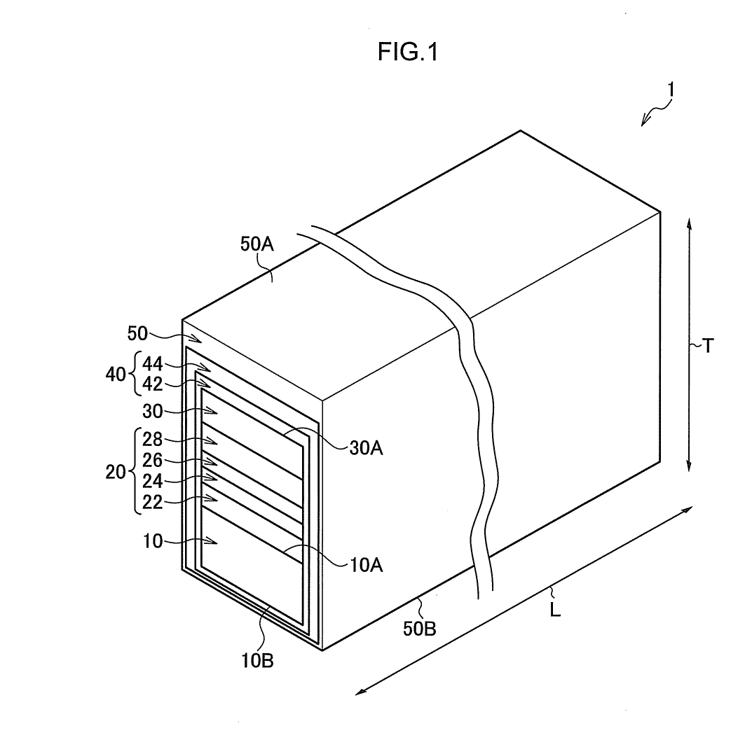

FIG. 1 is a perspective view showing the layered structure of a superconducting wire 1 relating to the embodiment of the present invention.

As shown in FIG. 1, the superconducting wire 1 has, at one main surface 10A side thereof in the direction of thickness T of a substrate 10, a layered structure in which an intermediate layer 20, a superconducting layer 30, a stabilization layer 40 and an insulating layer 50 are layered in that order.

The substrate 10 is formed in the shape of a tape that extends in the arrow L direction in the drawings (hereinafter called the length L direction). A low-magnetic metal substrate or a ceramic substrate is used for this substrate 10. Metals such as, for example, Co, Cu, Ni, Ti, Mo, Nb, Ta, W, Mn, Fe, Cr, Ag and the like that have excellent strength and heat resistance, or alloys thereof, are used as the material of the metal substrate. Stainless steel, Hastelloy (registered trademark), and other nickel-based alloys, that excel with respect to corrosion resistance and heat resistance, are particularly preferable. Further, various types of ceramics may be placed on these various types of metal materials. Further, MgO, SrTiO₃, or yttria-stabilized zirconia or the like for example is used as the material of the ceramic substrate.

The intermediate layer 20 is a layer that is provided between the substrate 10 and the superconducting layer 30 in order to, for example, realize high biaxial orientation at the superconducting layer 30. A physical characteristic value, such as the coefficient of thermal expansion or the lattice constant or the like for example, of this intermediate layer 20 exhibits a value that is between those of the substrate 10 and the superconductor that structures the superconducting layer 30. Further, the intermediate layer 20 may be a single-layer structure or may be a multilayer structure. In the case of a multilayer structure, the number of layers and the types thereof are not limited, but, as shown in FIG. 1 for example, the intermediate layer 20 may be a structure in which a bed layer 22 that includes amorphous Gd₂Zr₂O_{7-δ} (where δ is the non-stoichiometric amount of oxygen) or the like, a forcibly oriented layer 24 that contains crystalline MgO or the like and is formed by the IBAD method, an LMO layer 26 that contains LaMnMO_{3+δ} (where δ is the non-stoichiometric amount of oxygen), and a cap layer 28 that contains CeO₂ or the like, are layered in that order.

The superconducting layer 30 is provided (deposited) on a surface in the thickness direction of the intermediate layer 20, and includes an oxide superconductor, and in particular, a copper oxide superconductor. REBa₂Cu₃O_{7-δ} (called an RE-based superconductor), that serves as a high-temperature superconductor, is preferable as the copper oxide superconductor. Note that the RE in the RE-based superconductor is a single rare earth element such as Y, Nd, Sm, Eu, Gd, Dy, Ho, Er, Tm, Yb, Lu or the like, or is plural rare earth elements, and thereamong, is preferably Y for reasons such as it is difficult for substitution on the Ba site to occur, and the like. Further, δ is the non-stoichiometric amount of oxygen, and, for example, is greater than or equal to 0 and less than or equal to 1, and nearer to 0 is preferable from the standpoint of the superconducting transition temperature being high. Note that, with regard to the non-stoichiometric amount of oxygen, if high-pressure oxygen annealing or the like is carried out by using a device such as an autoclave or the like, there are also cases in which δ is less than 0, i.e., takes-on a negative value.

The stabilization layer 40 covers at least a surface 30A of the superconducting layer 30 and another main surface 10B of the substrate 10. Preferably, it is preferable that the stabilization layer 40 include a metal element such as copper or the like. The stabilization layer 40 may cover not only this surface 30A and main surface 10B, but also the entire peripheries of the substrate 10 and the intermediate layer 20 and the superconducting layer 30 as shown in FIG. 1, including the side surfaces of the superconducting layer 30, the side surfaces of the intermediate layer 20, and the side surfaces of the substrate 10.

This stabilization layer 40 may be a single-layer structure or may be a multilayer structure. In the case of a multilayer structure, the number of layers and the types thereof are not limited, but, as shown in FIG. 1 for example, the stabilization layer 40 may be a structure in which a silver stabilization layer 42 formed of silver and a copper stabilization layer 44 formed of copper are layered in that order.

The insulating layer 50 covers the stabilization layer 40, and has identification portions that identify the substrate 10 side and the superconducting layer 30 side.

For example, means (1) through (5) that are described hereinafter are examples of the identification portions that identify the substrate 10 side and the superconducting layer 30 side. Note that these means may be combined.

(1) An identification mark that identifies the substrate 10 side and the superconducting layer 30 side is provided at the insulating layer 50.

Concretely, a mark such as O or X or the like, or text such as “front” or “reverse” or the like, is provided as an identification mark by printing or engraving or the like on a surface 50A at the superconducting layer 30 side of the insulating layer 50, or on a surface 50B at the substrate 10 side of the insulating layer 50.

Owing to this identification mark, the substrate 10 side and the superconducting layer 30 side can be identified by the vision of the user of the superconducting wire.

In particular, if a three-dimensional identification mark is provided, the substrate 10 side and the superconducting layer 30 side can be identified not only by vision, but also by touch. However, there are also cases in which a three-dimensional identification mark may get in the way when the superconducting wire 1 is made into a coil or is used, and therefore, it is preferable to make the thickness of the identification mark be as thin as possible to the extent that it can be identified by touch.

(2) The roughness of the surface 50A at the superconducting layer 30 side of the insulating layer 50 and the roughness of the surface 50B at the substrate 10 side are made to differ.

Concretely, the roughness (arithmetic mean roughness Ra) of the surface 50A at the superconducting layer 30 side and the roughness (arithmetic mean roughness Ra) of the surface 50B at the substrate 10 side of the insulating layer 50 are made to differ by abrading the surface 50A or the surface 50B or varying the materials of the insulating layer 50 at the superconducting layer 30 side and the substrate 10 side.

Due to this difference in the roughnesses Ra, the substrate 10 side and the superconducting layer 30 side can be identified by the touch of the user of the superconducting wire. Further, in a case in which this superconducting wire 1 is made into a coil, the wound surface 50A and surface 50B contact, and the unique effect of being able to prevent winding offset due to the difference in these roughnesses Ra also is achieved.

From the standpoint of all users of the superconducting wire being able to ascertain the difference in the surface roughnesses by touch, it is preferable that there be a difference of greater than or equal to 10 μm between the roughness Ra of the surface 50A at the superconducting layer 30 side and the roughness Ra of the surface 50B at the substrate 10 side of the insulating layer 50. Further, it is desirable that these be roughnesses of an extent so as to not cause problems when applied to the device of application, and therefore, it is good for there to be a difference of less than or equal to 500 μm and preferably less than or equal to 100 μm.

(3) The hardness of the superconducting layer 30 side of the insulating layer 50 and the hardness of the substrate 10 side of the insulating layer 50 are made to differ.

Concretely, the Vickers hardness of the superconducting layer 30 side of the insulating layer 50 and the Vickers hardness of the substrate 10 side of the insulating layer 50 are made to differ by varying the materials of the insulating layer 50 at the superconducting layer 30 side and the substrate 10 side.

Due to this difference in the Vickers hardnesses, the substrate 10 side and the superconducting layer 30 side can be identified by the touch of the user of the superconducting wire.

From the standpoint of all users of the superconducting wire being able to ascertain the difference in the surface roughnesses by touch, it is preferable that there be a difference of at least greater than or equal to Hv 30, and desirably greater than or equal to Hv 150, between the Vickers hardness of the superconducting layer 30 side and the Vickers hardness of the substrate 10 side. Further, it is desirable that there be hardnesses of an extent so as to not cause problems when applied to the device of application, and therefore, it is good for there to be a difference of less than or equal to Hv 1000 and preferably less than or equal to Hv 500.

(4) The corner portions of the insulating layer 50 are rounded, or the curvature of rounding at the superconducting layer 30 side of the insulating layer 50 and the curvature of rounding at the substrate 10 side of the insulating layer 50 are made to differ.

Concretely, the corner portions of either one of the superconducting layer 30 side of the insulating layer 50 and the substrate 10 side of the insulating layer 50 are rounded. In a case in which the corner portions of the both are rounded, the curvature of the rounding at the superconducting layer 30 side of the insulating layer 50 and the curvature of the rounding at the substrate 10 side of the insulating layer 50 are made to differ.

Due thereto, the substrate 10 side and the superconducting layer 30 side can be identified by the vision and the touch of the user of the superconducting wire.

(5) The colors are made to differ at the surface 50A at the superconducting layer 30 side of the insulating layer 50 and the surface 50B at the substrate 10 side.

Concretely, the colors are made to differ at the surface 50A at the superconducting layer 30 side of the insulating layer 50 and the surface 50B at the substrate 10 side, by varying the material of the insulating layer 50 at the superconducting layer 30 side and the substrate 10 side, or varying the reflectivities by varying the roughnesses Ra at the superconducting layer 30 side and the substrate 10 side in the same way as in above-described (2), or varying the reflectivities by varying the thickness of the insulating layer 50 at the superconducting layer 30 side and the substrate 10 side by winding insulating tape that becomes the insulating layer 50, or, as described later, providing a metal oxide insulating portion, that contains an oxide of the metal element that is included in the stabilization layer 40 (copper oxide in the present embodiment), at least at the superconducting layer 30 side of the insulating layer 50.

Due thereto, the substrate 10 side and the superconducting layer 30 side can be identified by the vision of the user of the superconducting wire. Further, in the case of providing a metal oxide insulating portion, the adhesion between the insulating layer 50 and the stabilization layer 40 increases, the superconducting wire 1 is strong with respect to pulling in the length L direction of the substrate 10, and further, entry of liquids and impurities into between the insulating layer 50 and the stabilization layer 40 can be suppressed, as compared with a case of merely winding an insulating tape.

<<Details of Metal Oxide Insulating Portion>>

A case of providing a metal oxide insulating portion, that contains an oxide of the metal element that is included in the stabilization layer 40, at least at the superconducting layer 30 side of the insulating layer 50 is described in further detail next.

In the case of providing a metal oxide insulating portion only at the superconducting layer 30 side, the insulating layer 50 other than at the superconducting layer 30 side is formed by insulating tape or the like.

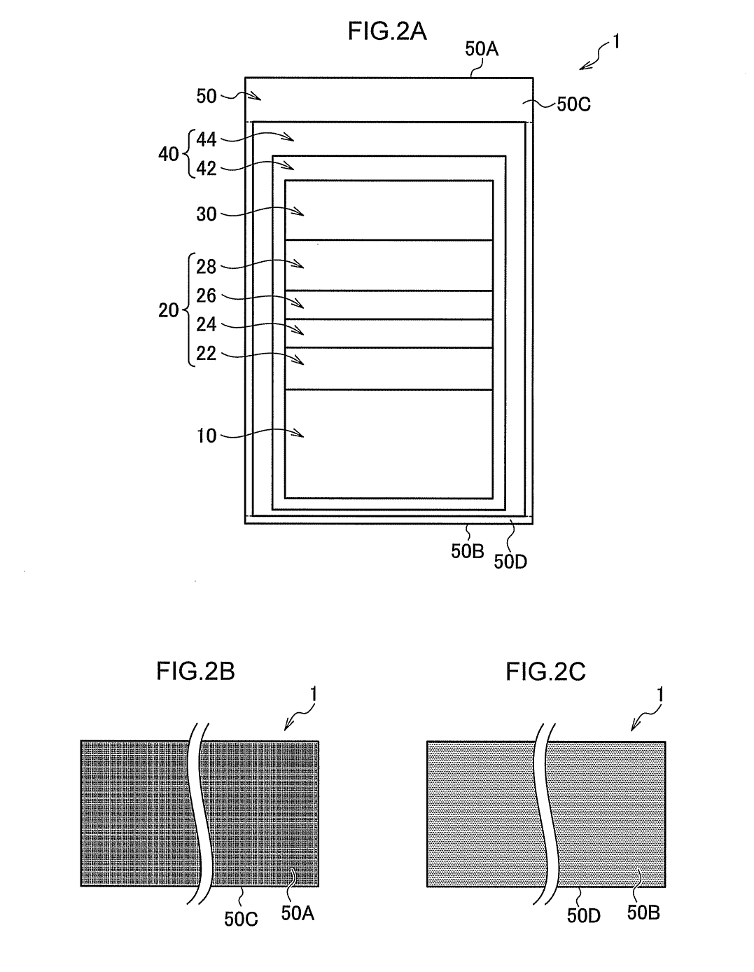

Further, as shown in FIG. 2A, the aforementioned metal oxide insulating portion is formed at the entire surface of the stabilization layer 40 (the copper stabilization layer 44), and has, as identification portions, a first metal oxide insulating portion 50C that is formed at the superconducting layer 30 side and a second metal oxide insulating portion 50D that is formed at the substrate 10 side, and the colors of the first metal oxide insulating portion 50C and the second metal oxide insulating portion 50D may be made to differ from one another (refer to FIG. 2B and FIG. 2C). In order to make these colors differ, for example, it suffices to make the thickness of the first metal oxide insulating portion 50C and the thickness of the second metal oxide insulating portion 50D differ.

Note that, as shown in FIG. 2A, the thickness of the first metal oxide insulating portion 50C is preferably greater than the thickness of the second metal oxide insulating portion 50D. This is because, because there is the need to protect the superconducting layer 30 more than the substrate 10, strengthening of protection can be devised by making the thickness of the first metal oxide insulating portion 50C greater than the second metal oxide insulating portion 50D.

Further, this is because peeling-off of the insulating layer 50 or the stabilization layer 40 at the superconducting layer 30 side, where protection is needed, can be prevented.

Further, because current flows to the superconducting layer 30 when the superconducting wire 1 is used, the insulating layer 50 at the superconducting layer 30 side must have a better insulating characteristic. Accordingly, it is preferable to make the thickness of the first metal oxide insulating portion 50C be greater than the thickness of the second metal oxide insulating portion 50D, and to make the insulating characteristic of the first metal oxide insulating portion 50C be better than the insulating characteristic of the second metal oxide insulating portion 50D.

Further, it is preferable that the first metal oxide insulating portion 50C and the second metal oxide insulating portion 50D, and in particular the first metal oxide insulating portion 50C, be smaller than the thickness of the stabilization layer 40. This is because, as will be described later, portions obtained by subjecting the stabilization layer 40 to an oxidizing treatment can be used as the first metal oxide insulating portion 50C and the second metal oxide insulating portion 50D, and a metal oxide, that is formed by oxidizing the metal element of the stabilization layer 40, is generally weaker than the metal element of the stabilization layer 40, and therefore, by ensuring the thickness of a stronger stabilization layer 40, a deterioration in mechanical strength can be suppressed.

Further, it is preferable that, between the metal oxide insulating portion of the insulating layer 50 and the stabilization layer 40, the metal element of the stabilization layer 40 (copper element in the present embodiment) and an oxide of the metal element (copper oxide in the present embodiment) both exist, and that there be provided a sloping-composition layer in which the ratio of the oxide of the metal element to that metal element as a simple substance continuously becomes greater toward the metal oxide insulating portion. This is because, due thereto, the adhesion of the insulating layer 50 and the stabilization layer 40 improves.

Further, as shown in FIG. 2A, as another form in which the insulating layer 50 has the first metal oxide insulating portion 50C and the second metal oxide insulating portion 50D that is formed at the substrate 10 side and the colors of the first metal oxide insulating portion 50C and the second metal oxide insulating portion 50D are made to differ from one another, there may be made to be different colors by controlling the reflectivities of the visible region by differing the surface shape of the first metal oxide insulating portion 50C (the surface 50A at the superconducting layer 30 side) and the surface shape of the second metal oxide insulating portion 50D (the surface 50B at the substrate 10 side).

<<Method of Fabricating Metal Oxide Insulating Portion>>

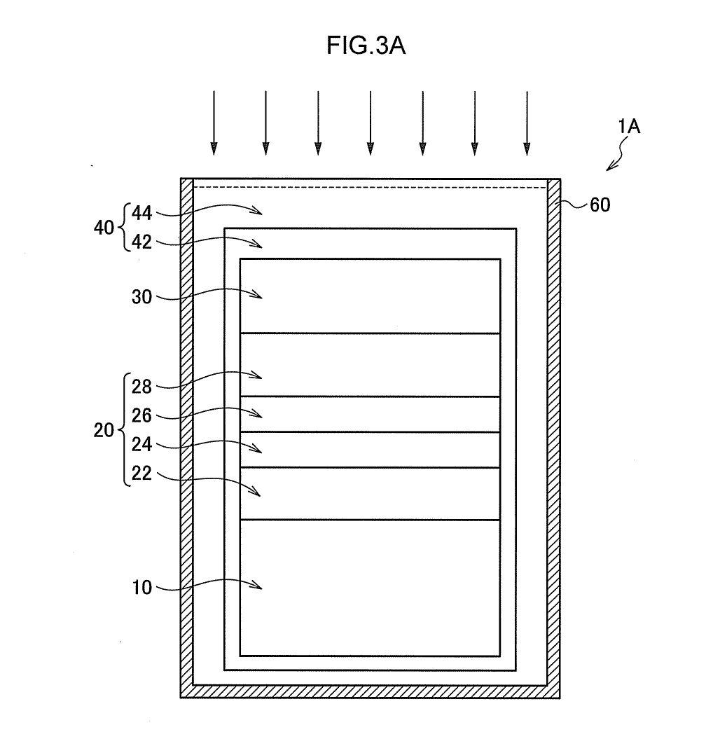

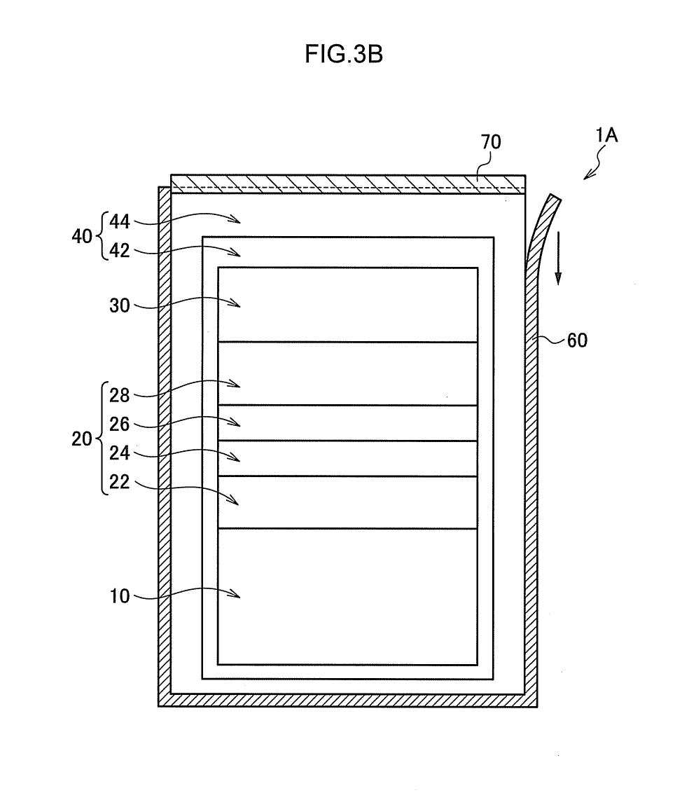

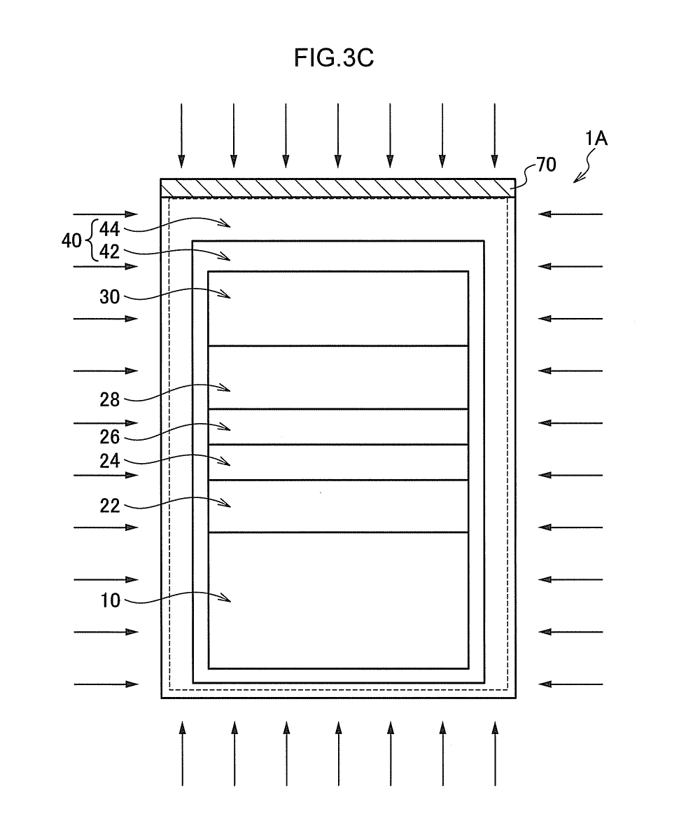

An example of a method of fabricating the above-described metal oxide insulating portion is described next. FIG. 3A through FIG. 3C are drawings showing some of the processes of fabricating the metal oxide insulating portion. Note that the dashed lines in the drawings show the boundary lines of a region that is to be oxidized or the boundary lines of a region that has been oxidized at the copper stabilization layer 44, and cannot be seen in actuality.

First, as shown in FIG. 3A, a superconducting wire 1A before processing, at which the periphery of the substrate 10, the intermediate layer 20 and the superconducting layer 30 is covered by the silver stabilization layer 42 and the copper stabilization layer 44 in that order, is prepared.

At the superconducting wire 1A, the periphery of the copper stabilization layer 44, except for the surface of the copper stabilization layer 44 at the superconducting layer 30 side, is covered by masking tape 60, and the surface of the copper stabilization layer 44 at the superconducting layer 30 side is subjected to an oxidization treatment, and a copper oxide layer 70 is obtained (refer to FIG. 3A and FIG. 3B). A method of immersion in a copper/copper alloy blackening agent that is a strong alkali boiling type, an ammonia (gas) gas phase method, an anodic oxidation method of the copper, and a method of carrying out a heat treatment in an oxidizing atmosphere are examples of the oxidization treatment. Note that, from the standpoint of it sufficing to not subject the superconducting wire 1A to a high-temperature treatment that is a cause of elements coming-out from the superconducting layer 30, it is preferable to use a method other than a heat treatment. Among the immersion method, the ammonia (gas) gas phase method and the anodic oxidation method of the copper, in order for the oxidization speed to be fast, it is preferable to use the ammonia (gas) gas phase method and the anodic oxidation method of the copper, from the standpoint of preventing control of the thickness of the metal oxide insulating portion (the copper oxide layer) from becoming difficult. However, in the case of an immersion method, control of the thickness of the metal oxide insulating portion (the copper oxide layer) can be made easy by weakening the concentration of the solution that is used and reducing the coated amount.

In the method of immersion in a blackening agent, for example, Ebonol C Special liquid can be used as the blackening agent. At this time, for the immersion conditions, the immersion temperature can be made to be 90° C. and the immersion time can be made to be 30 seconds for example. Further, electrolytic degreasing by an alkali degreasing material (e.g., processing temperature 60° C.:processing time 120 seconds) and surface activation by sulfuric acid may be carried out before immersion, and in particular, before the masking tape.

After the copper stabilization layer 44 at the superconducting layer 30 side is subjected to an oxidization treatment, as shown in FIG. 3B, the masking tape 60 is removed from the superconducting wire 1A.

Next, as shown in FIG. 3C, all of the surfaces of the copper stabilization layer 44 including the copper oxide layer 70 are subjected to an oxidization treatment. For the method of oxidization-treating all of the surfaces, using a method that is the same as the method of the oxidization treatment of the copper stabilization layer 44 at the superconducting layer 30 side is preferable from the standpoint of reducing bother. However, the oxidization treatment may be carried out by a method that is different than the method of the oxidization treatment of the copper stabilization layer 44 at the superconducting layer 30 side.

Due thereto, as shown in FIG. 2A, a metal oxide insulating portion (a copper oxide layer) that becomes the insulating layer 50 is formed at the periphery of the copper stabilization layer 44, and the superconducting wire 1 is obtained. Further, the metal oxide insulating portion has the first metal oxide insulating portion 50C that is formed at the superconducting layer 30 side and the second metal oxide insulating portion 50D that is formed at the substrate 10 side, and the thickness of the first metal oxide insulating portion 50C is greater than the thickness of the second metal oxide insulating portion 50D, for example, the thickness becomes about twice as large if the immersing conditions of the two times are made to be the same.

As a result, the first metal oxide insulating portion 50C appears as a dark black color due to the thickness thereof being large, and the second metal oxide insulating portion 50D appears as a light black color due to the thickness thereof being small, and the colors are seen as being different from one another, and the substrate 10 side and the superconducting layer 30 side can be identified.

Further, the step of forming the copper stabilization layer 44 and the oxidization treatment step may be carried out in continuation. In this case, a superconducting wire at which the silver stabilization layer 42 is the outermost surface is prepared. This superconducting wire is immersed for 30 seconds at room temperature in a solution of 100 g/L of sodium persulfate and 50 g/L of sulfuric acid so as to chemically roughen the surface of the silver stabilization layer 42, and thereafter, rinsing is carried out. Further, the rinsed superconducting wire is immersed in a solution of 180 to 250 g/L of copper sulfate, 45 to 65 g/L of sulfuric acid, and 20 to 60 mg/L of chloride ions, and the superconducting wire is subjected to a plating process at room temperature, and the copper stabilization layer 44 is formed.

While conveying the superconducting wire, masking is carried out on one surface thereof, and a blackening agent is applied to the surface at which masking is not carried out. The immersion temperature at this time is made to be 90° C., and the immersion time is made to be 30 seconds. After rinsing and drying, the masking is removed, and it suffices to carry out an oxidization treatment on the superconducting wire.

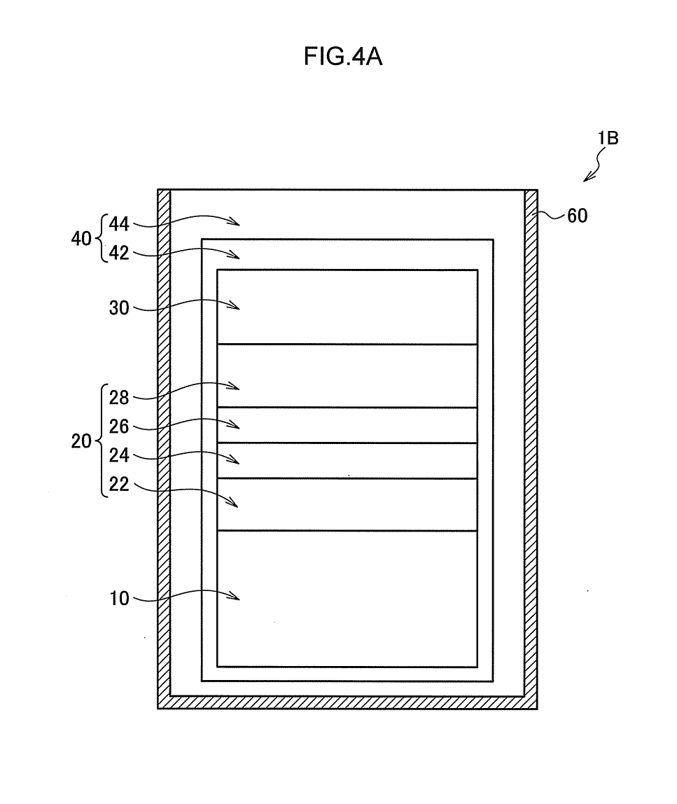

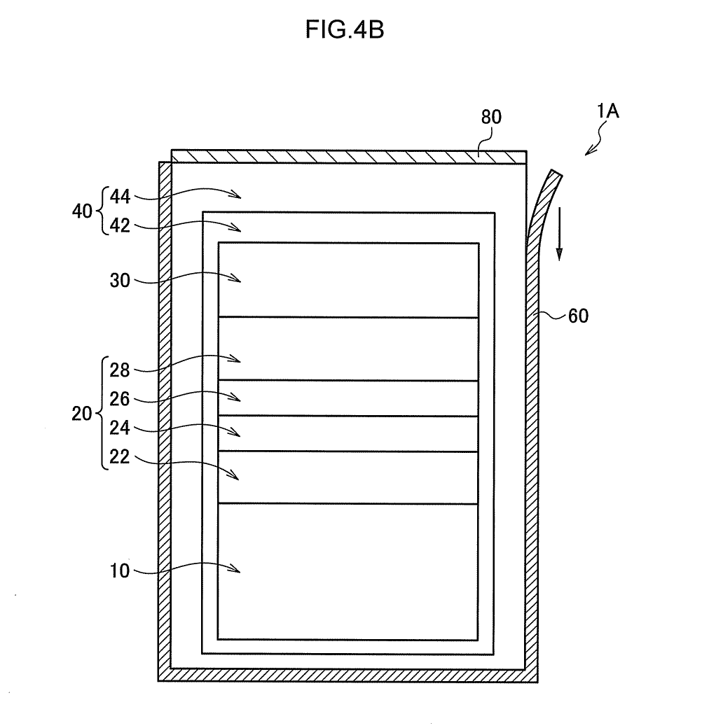

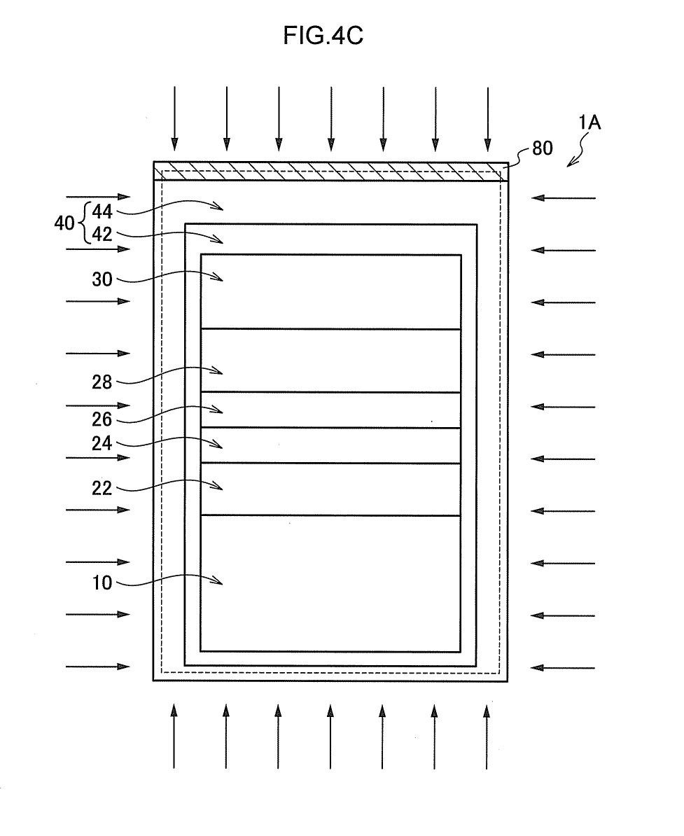

Another example of a method of fabricating the above-described metal oxide insulating portion is described next. FIG. 4A through FIG. 4C are drawings showing some of other processes of fabricating the metal oxide insulating portion. Note that the dashed lines in the drawings show the boundary lines of a region that is to be oxidized or the boundary lines of a region that has been oxidized at the copper stabilization layer 44, and cannot be seen in actuality.

As a method of making the surface shape of the first metal oxide insulating portion 50C and the surface shape (the reflectivity of the visible region) of the second metal oxide insulating portion 50D differ, the surface shape of the copper stabilization layer 44 can be controlled by adjusting the plating liquid for forming the copper stabilization layer 44.

For example, as shown in FIG. 4A, at a superconducting wire 1B before processing at which the periphery of the substrate 10, the intermediate layer 20 and the superconducting layer 30 is covered by the silver stabilization layer 42 and the copper stabilization layer 44 in that order, the periphery of the copper stabilization layer 44, except for the surface of the copper stabilization layer 44 at the superconducting layer 30 side, is covered by the masking tape 60. The superconducting wire 1B is immersed for 30 seconds at room temperature in a solution of 100 g/L of sodium sulfate and 50 g/L of sulfuric acid so as to chemically roughen the surface of the copper stabilization layer 44 at the superconducting layer 30 side, and rinsing is carried out. Thereafter, the superconducting wire 1B is immersed in a plating liquid (pH 4.5, 30° C.) formed from 100 g/L of nickel sulfate (NiSO₄.5H₂O) (the Ni is 24 g/L) and 4 g/L of copper (II) sulfate (CuSO₄.5H₂O) (the Cu is 1 g/L). A platinum plated titanium mesh that is an insoluble anode is used as the anode, electrolysis is carried out for 20 seconds at a current density of 2 A/dm², and after the electrolysis, rinsing and drying are carried out. Due thereto, as shown in FIG. 4B, a copper layer, that has a surface shape different from the copper stabilization layer 44 that was masked (a copper layer exhibiting a uniform black color) 80, is formed on the surface of the copper stabilization layer 44 at the superconducting layer 30 side.

Then, in FIG. 4B, the masking tape 60 is removed from the superconducting wire 1A. Next, as shown in FIG. 4C, all of the surfaces of the copper stabilization layer 44 including the copper layer (the copper layer exhibiting a uniform black color) 80 are oxidization-treated.

Due thereto, as shown in FIG. 2A, a metal oxide insulating portion (copper oxide layer) that becomes the insulating layer 50 is formed at the periphery of the copper stabilization layer 44, and the superconducting wire 1 is obtained. Further, the metal oxide insulating portion has the first metal oxide insulating portion 50C that is formed at the superconducting layer 30 side and the second metal oxide insulating portion 50D that is formed at the substrate 10 side, and the color of the copper layer 80 is darker (the reflectivity is lower) than the color of the other stabilization layer 44. Therefore, by carrying out the same oxidization treatment, the color (reflectivity) of the first metal oxide insulating portion 50C becomes darker (lower) than the second metal oxide insulating portion 50D.

As a result, the reflectivity of the visible region at the first metal oxide insulating portion 50C is lower than the second metal oxide insulating portion 50D, and the first metal oxide insulating portion 50C appears as a dark black color, and the colors of the first metal oxide insulating portion 50C and the second metal oxide insulating portion 50D appear as being different from one another, and the substrate 10 side and the superconducting layer 30 side can be identified.

### MODIFIED EXAMPLES

Note that specific embodiments of the present invention have been described in detail, but the present invention is not limited to these embodiments, and it will be clear to those skilled in the art that various other embodiments are possible within the scope of the present invention. For example, the above-described plural embodiments can be implemented by being combined appropriately. Further, the following modified examples may be combined appropriately.

For example, not only may the substrate 10 side and the superconducting layer 30 side be identified as in the above-described embodiments, but at the metal oxide insulating portions of the insulating layer 50, there may be end portion identification portions that identify one end portion and the other end portion in the length L direction of the superconducting wire 1, or one end portion and the other end portion in the short-side direction of the superconducting wire 1. For example, if the one end portion and the other end portion in the length L direction can be identified, it is useful when understanding a characteristic change table from the one end portion to the other end portion, or the like. Further, if the one end portion and the other end portion in the short-side direction can be identified, it is useful when specifying damage, or the like.

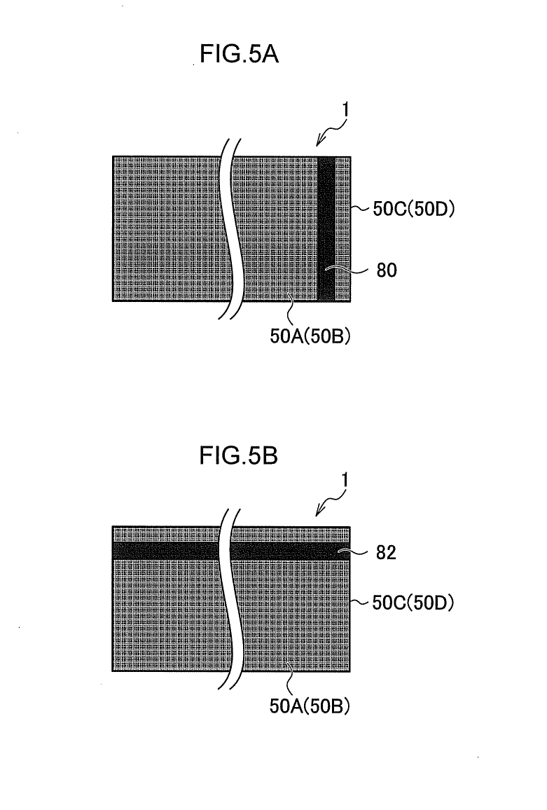

In this case, from the standpoint of it sufficing to not increase the number of other processing steps, it is preferable that a portion of the first metal oxide insulating portion 50C or the second metal oxide insulating portion 50D that have been formed by the oxidization treatment be subjected to a further oxidization treatment so that the color thereof is changed (the color is made even more dark), and an end portion identification portion 80, that is rectilinear and extends in the short-side direction such as shown in FIG. 5A, or an end portion identification portion 82, that is rectilinear and extends in the length L direction such as shown in FIG. 5B, is provided.

Further, in the embodiments, the copper oxide is obtained by oxidizing the copper element at the time of the oxidization treatment, by using the copper stabilization layer. However, a metal layer of cobalt or iron or the like may be disposed instead of the copper stabilization layer or on the surface of the copper stabilization layer, and the other metal element such as cobalt or iron or the like may be oxidized. In this case, there are also cases in which the metal oxide insulating portion appears as blue or brown, and not black as described in the embodiments.

Further, as described in the embodiments, a case is described in which the colors of the first metal oxide insulating portion 50C and the second metal oxide insulating portion 50D differ from one another due to the shade of the color. However, the oxidization may be contrived such that the types of the colors differ from one another. Concretely, adjusting the oxidization treatment method, and varying the valences of the metals of the first metal oxide insulating portion 50C and the second metal oxide insulating portion 50D, and, for example, disposing a metal layer of iron instead of the copper stabilization layer or on the surface of the copper stabilization layer, and making the first metal oxide insulating portion 50C be Fe₃O₄ that appears as black and making the second metal oxide insulating portion 50D be Fe₂O₃ that appears as red, or the like, may be considered.

Further, all of or a portion (the LMO layer 26 or the like) of the intermediate layer 20 can be omitted.

The disclosure of Japanese Patent Application No. 2012-092803 is, in its entirety, incorporated by reference into the present Description.

All publications, patent applications, and technical standards mentioned in the present Description are incorporated by reference into the present Description to the same extent as if such individual publication, patent application, or technical standard was specifically and individually indicated to be incorporated by reference.

1. A superconducting wire comprising:
a substrate;
a superconducting layer that is layered on one main surface side of the substrate;
a stabilization layer that covers a surface of the superconducting layer and another main surface of the substrate; and
an insulating layer that covers a surface of the stabilization layer, and that has an identification portion that identifies the substrate side and the superconducting layer side.

2. The superconducting wire of claim 1, wherein:
the stabilization layer contains a metal element, and
the insulating layer has, as the identification portion, a metal oxide insulating portion that is formed at least at the superconducting layer side and contains an oxide of the metal element.

3. The superconducting wire of claim 2, wherein:
the metal oxide insulating portion has, as the identification portion, a first metal oxide insulating portion that is formed at the superconducting layer side and a second metal oxide insulating portion that is formed at the substrate side, and
colors of the first metal oxide insulating portion and the second metal oxide insulating portion differ from one another.

4. The superconducting wire of claim 3, wherein a thickness of the first metal oxide insulating portion is greater than a thickness of the second metal oxide insulating portion.

5. The superconducting wire of claim 2, wherein a thickness of the metal oxide insulating portion is smaller than a thickness of the stabilization layer.

6. The superconducting wire of claim 2, wherein, between the metal oxide insulating portion and the stabilization layer, the metal element and an oxide of the metal element both exist, and there is provided a sloping-composition layer in which a ratio of the oxide of the metal element with respect to the metal element as a simple substance continuously becomes greater toward the metal oxide insulating portion.

7. The superconducting wire of claim 2, wherein the metal oxide insulating portion has an end portion identification portion that identifies one end portion and another end portion in a length direction of the superconducting wire or one end portion and another end portion in a short-side direction of the superconducting wire.

8. The superconducting wire of claim 1, wherein a surface roughness of the superconducting layer side at the insulating layer is different than a surface roughness of the substrate side at the insulating layer.

9. The superconducting wire of claim 1, wherein a Vickers hardness of the superconducting layer side at the insulating layer is different than a Vickers hardness of the substrate side at the insulating layer.
